(19) United States
(12) Patent Application Publication
(10) Pub. No.: US 2024/0344209 A1
(43) Pub. Date: Oct. 17, 2024

(54) METHOD FOR ALLOCATING ELECTRICAL ENERGY WITHIN AN ELECTROLYSIS PLANT

(71) Applicant: H2i GreenHydrogen GmbH, Wallern an der Trattnach (AT)

(72) Inventor: Dietmar NEUBACHER, Graz (AT)

(73) Assignee: H2i GreenHydrogen GmbH, Wallern an der Trattnach (AT)

(21) Appl. No.: 18/574,610

(22) PCT Filed: Jun. 29, 2022
(86) PCT No.: PCT/AT2022/060230

§ 371 Date: Dec. 27, 2023

(30) Foreign Application Priority Data
Jul. 1, 2021 (AT) A 50551/2021

(51) Int. Cl. C25B 1/044; C25B 15/027; C25B 15/08; H02J 3/14; H02J 11/00; H02J 15/00

(52) U.S. Cl. CPC C25B 1/044; C25B 15/027; C25B 15/083; H02J 3/14; H02J 11/00; H02J 15/008; H02J 2300/20

(57) ABSTRACT

The disclosure relates to a method for allocating electrical energy within an electrolysis plant for producing oxygen and hydrogen. The electrolysis plant comprises a system control device and at least two management apparatuses. Each management apparatus comprises at least one management control device and at least two electrolysis devices. The allocation method comprises method steps and method sequences by means of which the electrolysis process can be particularly advantageously controlled. Thus, a particularly flexible design of the electrolysis process can be implemented, while at the same time high efficiency and an extended service life of the individual components of the electrolysis plant are achieved. The flexible design of the electrolysis process is reflected especially in an expanded range of application of the electrolysis plant.

The invention relates to a method for allocating electrical energy within an electrolysis plant for producing oxygen and hydrogen, as disclosed in the claims. The method is intended for a flexible design of the electrolysis process for producing oxygen and hydrogen with simultaneously high efficiency and an extended service life of the individual components of the electrolysis plant.

EP2350352B1 shows a method for distributing electrical energy to a plurality of electrolysis device modules. However, the usability of an electrolysis plant is only partially satisfactory with this process.

The object of the present invention was to overcome the disadvantages of the prior art and to provide a method by means of which the use of an electrolysis plant is extended with regard to its range of applications and improved with regard to the configuration of the electrolysis process.

This object is achieved by a method according to the claims.

According to the invention, a method is provided for allocating electrical energy within an electrolysis plant for producing oxygen and hydrogen. The electrolysis plant comprises a system control device, at least two management apparatuses, wherein the at least two management apparatuses each comprise at least one management control device and at least two electrolysis devices. In this sense, a management apparatus is understood to be a functional partial area of the electrolysis plant. The allocation method comprises the following method steps:
detecting a supply capacity of electrical energy that can be obtained and utilized from an electrical supply via a communication interface of the system control device;
determining a respective target operating range for each of the at least two management apparatuses by the system control device;
transmitting the intended target operating ranges to the respective one of the at least two management apparatuses;
determining a respective target working state or the target working states for each electrolysis device by the respective management control device of the respective management apparatus;
specifying the intended target working state for the respective electrolysis device.

The method according to the invention is further characterized in that the respective management control device of the at least two management apparatuses determines characteristic operating values of each electrolysis device by means of a respective state detection device. The characteristic operating parameters determined are used to draw conclusions about the electrolysis process within the electrolysis devices. This makes it possible, for example, to determine the current working state of an electrolysis device.

Furthermore, the respective management control device of the at least two management apparatuses determines an available processing capacity of the management apparatuses with the aid of the characteristic operating parameters and transmits the available processing capacity to the system control device. The available processing capacity thus represents a possible capacity to absorb electrical power to carry out the electrolysis of an entire management apparatus.

The system control device carries out a balancing between the available processing capacities of the at least two management apparatuses and the supply capacity that can be obtained from and utilized by the electrical supply. If, for example, the available processing capacities correspond to the obtainable and utilizable supply capacity, one possible mode of operation of the electrolysis plant is that the complete obtainable and utilizable supply capacity is used for the electrolysis process in accordance with the available processing capacities.

Based on this balancing of the capacities and the currently possible and/or historical previous target operating ranges, the system control device determines an adapted target operating range for each of the at least two management apparatuses and specifies the adapted target operating ranges for the at least two management apparatuses. The electrical energy that can be obtained from and utilized by the electrical supply is then allocated to each of the at least two management apparatuses according to the respective target operating range.

Each management control device determines an adapted target working state for the electrolysis devices on the basis of the respective adapted target operating range and specifies these target working states for the electrolysis devices coupled to the respective management apparatuses. The management control device then allocates a quantity of electrical energy to each of the electrolysis devices according to the respective target working state.

The method according to the invention has the surprising advantage that each of the at least two management apparatuses is operated in a mutually independent manner and that all electrolysis devices are operated in a mutually independent manner, wherein at the same time the process of electrolysis is carried out in the best possible efficiency range, irrespective of the supply capacity that can be obtained and utilized. If, for example, the supply capacity that can be obtained and utilized is less than the processing capacities that can be provided, the balancing between the capacities makes it possible for the first of the at least two supply apparatuses to be operated with full utilization of all the electrolysis devices assigned to it, whereas the second of the supply apparatuses is operated with utilization of a part of the electrolysis devices allocated to it.

Similarly, the disclosed allocation method produces the advantageous effect that individual electrolysis devices are operated with regard to the most advantageous service life possible on the basis of the detection values of the respective state detection device. This is made possible by determining the processing capacity. For example, an electrolysis device may thus be subjected to an overload or underload over a defined period of time, even though the components of the electrolysis device are restored or protected in a subsequent working state. This also allows an electrolysis device to be transferred to a maintenance state during operation of the electrolysis plant without impairing the continued high-performance operation of the electrolysis plant. This possibility applies equally to an entire supply apparatus, since the disclosed method allows the supply apparatuses to be operated completely independently of each other and of the electrolysis devices.

A further advantage of the allocation method described above is that the electrolysis devices do not have to be based on a specific capacity with regard to the feasible electrical power. The state detection device of a supply device can be used to determine possible working states of the electrolysis devices by means of the characteristic operating parameters. Furthermore, this has the advantage that a reduction in performance is taken into account with regard to the feasible electrical power of an electrolysis device. Such a reduction may occur, for example, due to a process-related consumption of active components within an electrolysis device or due to ageing and the like. As a result, the safety of the electrolysis plant is increased by the allocation process described, as an undesirable overload is ruled out.

Furthermore, it may be appropriate for the electrical supply to be provided by an energy generating company, an energy production facility, an energy generating community and/or an energy supply service provider, in particular from renewable energy sources. The production of renewable energy, for example by generating electricity from biogas, solar energy, hydropower or wind energy, is subject to strong fluctuations in relation to the time of day and the seasons. The advantages of the allocation method according to the invention are all the more apparent when such sources are used, since the balancing between the available processing capacities and the supply capacity that can be obtained and utilized reacts to the fluctuations in the supply capacity that can be obtained and utilized. At the same time, the electrolysis plant is always operated at an optimum efficiency level for the respective operating point by using the allocation method. In this way, the highest possible degree of utilization of renewable energy sources is achieved.

Furthermore, it may be provided that the respective target operating range for the at least two management apparatuses comprises at least one mode of operation plus a feasible consumption of electrical power. The advantage here is that a standby mode may be specified for a supply apparatus. Particularly with regard to a possible reduction in supply capacity, a supply apparatus may thus be kept or brought on standby even if the feasible consumption of electrical power is zero. Components of the electrolysis plant that are prone to degradation or damage due to their chemical properties when completely shut down can therefore be protected by the standby mode.

Furthermore, it may be provided that the system control device is configured to determine at least one operating mode, in particular a rinsing mode, an idle mode, a maintenance mode, an emergency mode, a start-up mode, a shutdown mode and/or an electrolysis mode, by balancing the available processing capacities and the utilizable supply capacity. The advantage here is that the range of applications for the electrolysis plant is extended. For example, a rinsing mode may be preset in advance to prepare the electrolysis devices with subsequent idle mode. From the idle mode, a start-up mode and an operation with corresponding obtainable and usable supply capacity, i.e. an electrolysis mode, may be realized directly. This will significantly reduce the response time of the electrolysis plant to changes in supply capacity. As a result, the operation for the control service of an electrical supply network may be implemented in a high-performance manner. At the same time, the possibility of specifying the operating mode means that the components of the electrolysis device may be operated in a way that preserves their service life, especially if, for example, electrolysis devices with ion-exchange membranes are used.

An embodiment according to which it may be provided that the respective target working state for an electrolysis device comprises at least one consumption of electrical power, which electrical power is used by the electrolysis process, is also advantageous. The advantage here is that the electrolysis devices are operated without any control or regulation devices. The respective target working state is specified by the supply apparatus for the electrolysis device and already contains the electrical power that is converted by the electrolysis device through the electrolysis process. In particular, an electrical voltage is applied to the electrolysis device via the target working state, whereby a target production amount of hydrogen gas can be regulated.

In addition, it may be provided that the characteristic operating parameters are defined as a parameter set formed from measured variables, which parameter set comprises at least the electrical power consumption, the electrolyte or cell temperature, the volume flow of the electrolyte, the pressure of the hydrogen gas produced, the pressure of the electrolyte, and/or the degree of purity. The advantage here is that the exact technical state of the electrolysis devices can be detected and observed. For example, maintenance intervals can be optimally defined and planned as required, as the need for this can be determined by the characteristic operating parameters. At the same time, the safety of the electrolysis plant is increased because the occurrence of possible malfunctions can be detected at an early stage or even deduced ahead of time thanks to the possibility of state monitoring, taking into account the characteristic operating parameters. It is also advantageous that this increases the dynamics of the electrolysis devices with regard to changes in the working states and thus the entire electrolysis plant can react to changes in the supply capacity in a high-performance manner. It should be noted that the term electrolyte also includes alcohols or ultra-pure water.

Subsequently, a digital twin may be created using the characteristic operating parameters, which has far-reaching positive consequences. For example, a digital image of the system may be used to predict future operating states and to identify anomalies during operation or process-related degradation of active materials in the electrolysis devices. This also extends the usability of the electrolysis plant, as comparisons may be made between electrolysis devices.

According to a further embodiment, it may be provided that each state detection device of a management apparatus comprises at least one equivalent set of sensors for each electrolysis device, wherein the state detection device specifies the activity state of each sensor. The advantage of this is that sensors may be activated or put into standby mode as required. This makes it possible to implement an energy-saving control and regulation operation of the electrolysis plant in coordination with the supply capacity that can be obtained and utilized.

Furthermore, it may be provided that each management control device determines state characteristics for each electrolysis device by monitoring the characteristic operating parameters during operation of the plant, which state characteristics comprise at least the efficiency, the working state, the expected remaining service life, the start-up behavior and/or the power reserve of the respective electrolysis device. The advantage here is that it is possible to assess the individual electrolysis devices within the management control device using the state characteristics. This means that the allocation of electrical energy within a supply device may be ideally implemented in relation to the electrolysis devices. Furthermore, the determined state characteristics make it easier to use structurally different electrolysis devices in a single supply apparatus, which in turn makes it easier to compare and evaluate the electrolysis devices.

In combination with the determined characteristic operating parameters, this also enables an improved assessment of working states with regard to performance and safety. For example, time intervals for time-controlled processes such as electrolyte regeneration, maintenance, replacement, rinsing, induction of a gas bubble detachment or heating and cooling may be better estimated.

Furthermore, it may be advantageous for the processing capacity of each management apparatus to be determined by the respective management control device from working states that can be implemented by the electrolysis devices and meta-information of the electrolysis devices. In this context, working states that can be implemented are understood to mean that individual, not directly related working states are possible, from which the processing capacity of each management apparatus is determined. This results in the advantageous effect that the balancing of processing capacities and the obtainable and utilizable supply capacity may already be carried out with regard to optimum working states of the electrolysis devices. This means that special working states, such as rinsing or maintenance mode, may be taken into account directly in the balancing, which improves the overall effectiveness of the allocation method, as balancing control loops are saved. In addition, meta-information from the electrolysis devices is transmitted to the system control device, for example in order to detect the malfunctioning of an electrolysis device at an early stage.

In addition, it may be advantageous that the intended target working state for each electrolysis device is adapted by means of a respective resistance function, wherein this resistance function forms a weighted countermeasure against a disadvantageous working state of the respective electrolysis device, in particular a disadvantageous working state with regard to safety, efficiency and/or service life of the respective electrolysis device. The advantage of this is that a redundant loop is introduced in the process sequence within the control system of an electrolysis device in order to increase the safety of the electrolysis plant. At the same time, the resistance function improves the effectiveness of the allocation process in comparison with the supply control device in that target working states are adapted in an improved manner for each electrolysis device.

Furthermore, an advantageous extension of the allocation method may be that a blocking state of the electrolysis device may be activated by the respective resistance function, which blocking state prevents the allocation of electrical energy and/or influences the supply of electrolyte. It is therefore advantageously possible for a single electrolysis device to be separated from the electrolysis process. At the same time, this has the advantage that the allocation method and thus the operation of the remaining electrolysis plant may continue unaffected by this measure. This increases the safety of the electrolysis plant while maintaining a high level of availability.

Furthermore, it may be advantageous that the intended target operating range for each management apparatus is adjusted by means of a respective weighting function. The weighting function is implemented as a weighted countermeasure against a disadvantageous operating state of the respective management apparatus, wherein a disadvantageous operating state is meant in particular with regard to safety, efficiency and/or service life of the respective management apparatus. This has the advantage that each management apparatus within the respective management control device includes a control and/or regulation loop for the protection and/or optimized operation of itself. This results in the advantageous effect that the respective control and/or regulation loops of the components of the electrolysis plant may be used in each hierarchical level of the electrolysis plant, which leads to a reduction in the required computing capacities of the respective control devices. Due to the reduced computing capacities required, the entire allocation process is real-time capable, which has far-reaching positive consequences in terms of predictive and fast-reacting utilization of the electrolysis plant.

According to an advantageous further embodiment, it may be provided that the electrolysis plant for supplying the at least two management apparatuses comprises at least one water treatment, a water tank, a water supply unit, a pressurization and/or gas treatment unit for hydrogen gas, a heat exchanger unit and/or a power conversion unit, these being coupled to the system control device. This results in the advantage that combinable supply structures are arranged in a centralized manner within the electrolysis plant. This makes it possible for the management apparatuses to be operated independently. This results primarily from the interaction of the system control device and the supply control device in the disclosed allocation method. The control devices each have their own self-contained control and regulation range and may be operated independently of each other. This is reflected in the structural design of the electrolysis plant.

Furthermore, it may be useful for each of the at least two management apparatuses to comprise at least one electrolyte storage tank, an electrolyte preparation device, an electrolyte pumping device, a heat transfer unit and/or a power distribution unit for supplying the respective at least two electrolysis devices, wherein these are coupled to the management control device. In each case, the respective management apparatus comprises the management control device associated with it, which is configured to control and/or regulate the respective management apparatus. This possible design results in a self-contained electrolyte supply and self-contained regulation and/or control of the electrolysis process for each electrolysis device. This favors the allocation method described to the extent that the independence of the supply control devices is also ensured in the structural design. This means that working states, particularly with regard to safety measures, may be fully executed by the supply control device. At the same time, the electrolysis process may be effectively designed within each supply device, as the electrolyte flow can be adapted more precisely to the requirements of the electrolysis devices within each supply device. Furthermore, this results in the advantage that the supply devices may be structurally different from each other, while at the same time the disclosed allocation method continues to be used, in particular structurally different with respect to the processing capacity of a supply device.

Furthermore, it may be advantageous that a bidirectional communication connection with at least one further electrolysis plant, an internet-based interface and/or a database server may be established by means of the communication interface of the system control device. This results in the advantage that the system control device may use the communication interface to carry out the balancing between the supply capacity that can be obtained and utilized and the processing capacity that can be utilized in an ideal manner. For example, a predictive or forward-looking balancing is possible using alternative data sources with regard to a possible future supply capacity. Furthermore, the advantages of the allocation method for an electrolysis plant are enhanced in that, for example, a virtual aggregation of several electrolysis plants is implemented in an ideal manner and with the best possible utilization of the entire plant pool by the bidirectional communication capacity between the participants. In the sense of a predictive control of a plant pool of participants, an individual electrolysis plant may also specify a non-efficiency optimized target operating range for a management control device if this results in a later benefit in terms of time. Another example for this is the usability of the allocation method of the electrolysis plant for regulation services. As a result, the range of applications for the allocation process of the electrolysis plant is extended to the supply of fleet vehicles, hydrogen storage refueling or direct consumers in industrial applications, primarily through a demand-driven operation with regard to the production amount of hydrogen.

A method according to one of the preceding claims, characterized in that the system control device is configured to perform a plant analysis on the basis of historical and/or current processing capacities and/or on the basis of external data, wherein the external data is received by the communication interface. This results in the advantage that the plant analysis may be used for an anticipatory or predictive operation of the electrolysis plant in the sense of a trend analysis. This enables a high-performance operation, as the degree of utilization and thus the economic efficiency of the electrolysis plant is increased over a longer period of time and also in relation to an ideal economic utilization of the electrolysis plant, especially compared to a plant without an integrated plant analysis.

For the purpose of better understanding of the invention, this will be elucidated in more detail by means of the figures below. These show respectively in a very simplified schematic representation:

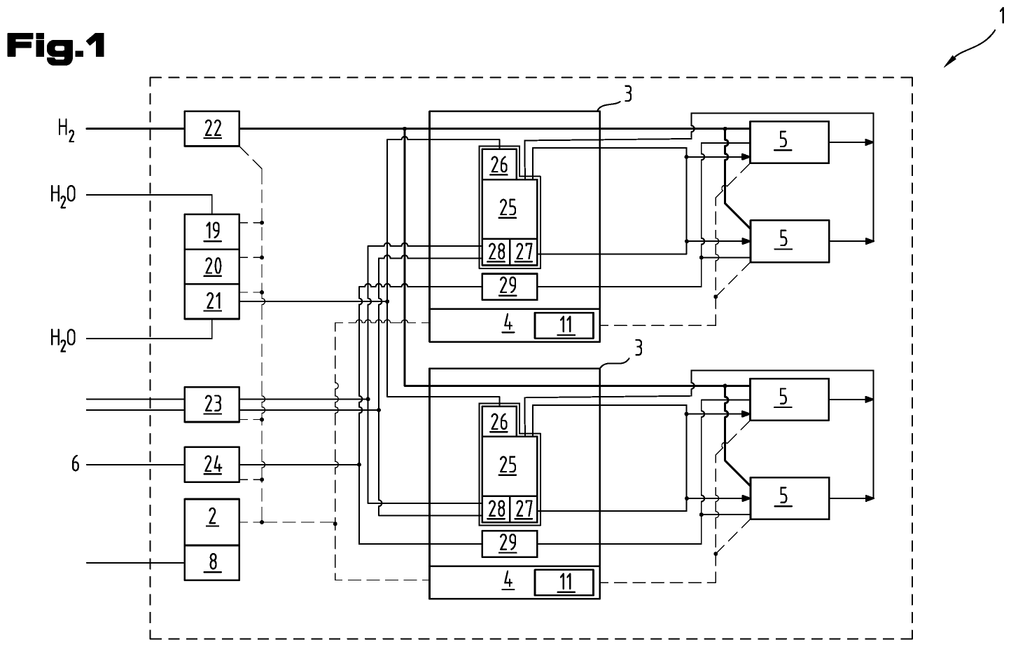

FIG. 1 a schematic representation of the structural design of an electrolysis plant for the application of the allocation method; and

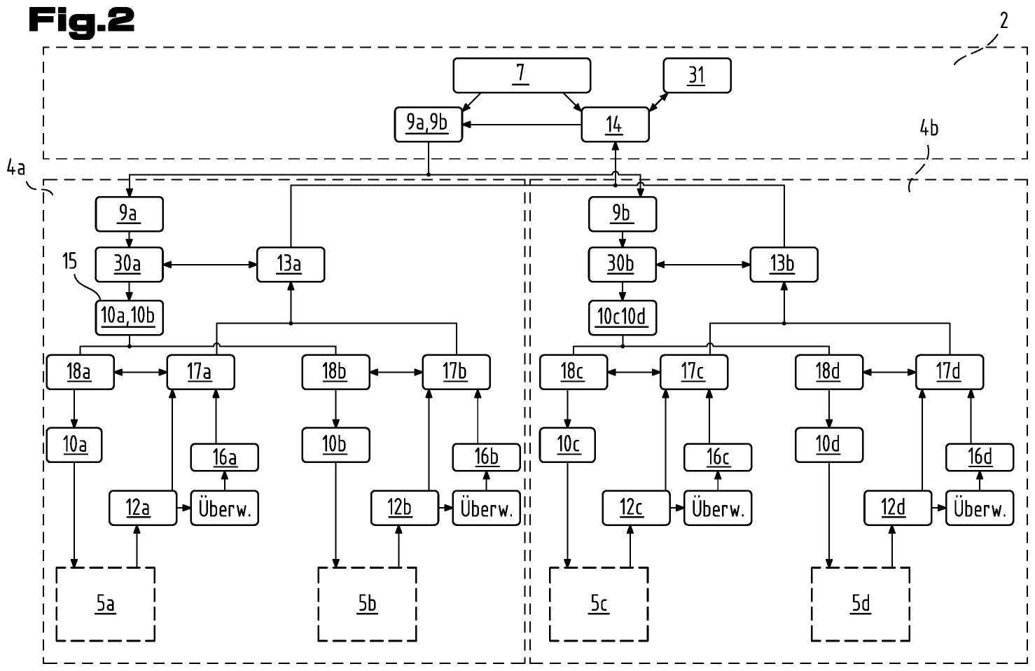

FIG. 2 a schematic representation of the method steps and method sequences in a first embodiment.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

Furthermore, it should be noted that terms from the reference signs list are used with and/or without a specific index in the description of the disclosure. If a precise differentiation of the terms with regard to their specific embodiment is not necessary, no indices are used. Conversely, for example, an electrolysis device 5a is differentiated from an electrolysis device 5b according to the respective description, wherein both are still electrolysis devices 5.

FIG. 1 shows a schematic representation of a possible and possibly independent embodiment of an electrolysis plant 1 to which electrolysis plant 1 the disclosed allocation method may be applied. This electrolysis plant 1 is configured to produce oxygen and hydrogen by means of an electrical energy through the electrochemical process of electrolysis with the aid of an electrolyte, the primary purpose of the plant being the production of hydrogen for further use, storage or feeding into a corresponding infrastructure. The electrolysis plant 1 shown may be operated independently or also within a group of several electrolysis plants 1 as a semi-autonomous plant. The electrolysis plant 1 always serves the purpose of producing hydrogen, wherein the oxygen produced by the electrolysis process does not have to be intended for any specific further use. In particular, the electrolysis plant 1 may be used for converting electrical energy from renewable sources into so-called “green” hydrogen. It should be noted at this point that, for the sake of readability, the term electrolyte used includes both media that are considered electrolytes and alcohols or ultra-pure water, as is common in technical jargon.

The embodiment of the electrolysis plant 1 shown here may comprise a water treatment 19, a water tank 20, a water supply unit 21, a pressurization and/or gas treatment unit 22 for hydrogen gas, a heat exchanger unit 23 and/or a power conversion unit 24. The aforementioned components may be allocated to the electrolysis plant 1 by connecting them to the system control device 2 for communication and control and/or regulation. Furthermore, the embodiment of the electrolysis plant 1 may comprise at least two management apparatuses 3.

A management apparatus 3 may be configured to ensure the supply of at least two electrolysis devices 5 as shown. The respective management apparatus 3 may include an electrolyte storage tank 25, an electrolyte preparation device 26, an electrolyte pumping device 27, a heat transfer unit 28 and/or a power distribution unit 29, all of which may be connected to the respective management control device 4 of the management apparatus 3 for communication and control and/or regulation. In each case, a management control device 4 is allocated to a management apparatus 3.

The electrolysis plant 1 may thus act as a hierarchically superordinate peripheral system for the management apparatuses 3 for providing all the necessary resources for the operation of each management apparatus 3. In the same way, each management apparatus 3 may provide all necessary means for the operation of each electrolysis device 5. This means that a closed electrolyte circuit may be set up for each management apparatus 3, which results in the far-reaching advantages already described above. This makes it possible for the management control device 4 of each management apparatus 3 to be operated in a manner independent of the electrolysis plant 1. From a systemic point of view, three hierarchical levels may be defined, with the top level being represented by the electrolysis plant 1, the middle level by the management apparatuses 3 and the lowest level by the electrolysis devices 5. It should be noted that the electrolysis plant 1 as well as each management apparatus 3 may be configured as a respective peripheral system with regard to the supply of the respective hierarchically subordinate partial ranges of the plant.

This possible structural embodiment of the electrolysis plant 1 in combination with the disclosed allocation method, as described in the introduction to the description, results in a large number of advantageous effects. For a better understanding, a possible embodiment of the method steps and method sequences is explained in more detail below.

FIG. 2 shows a schematic representation of the method steps and method sequences of a possible and possibly independent embodiment of the system, wherein the same reference signs or component designations are used for the same parts as in the preceding FIG. 1. In order to avoid unnecessary repetition, reference is made to the description of the preceding FIG. 1 and the preceding introduction to the description. As shown in FIG. 2, a possible embodiment may be that the allocation method in relation to the system control device 2 and the management control device 4 is carried out in two hierarchical levels. In order to provide a better understanding of the allocation method, the method is first described starting from the system control device 2 and then explained starting from the electrolysis devices 5.

Based on a supply capacity 7 that can be obtained and utilized which is provided, for example, by an electricity supply company, operating areas 9a, 9b for the management apparatuses 3a, 3b may be determined and transmitted to the management control devices 4a, 4b as intended. According to the respective target operating area 9 the electrical energy for carrying out the electrolysis process by the electrolysis devices 5 assigned to it is allocated to the respective management device 3. In the following, the allocation method according to FIG. 2 is described further for the management apparatus 3a, although the allocation method may be applied in the same way and in parallel or at different times for each additional management apparatus 3. Thus, based on the transmitted target operating range 9a, the working states 10a, 10b for the electrolysis device 5a, 5b assigned to the management apparatus 3a assigned to the electrolysis devices may be determined and the respective intended working state 10 may be assigned to the respective electrolysis device 5. The target operating state may, for example, be specified in the form of an applied voltage to the electrolysis devices 5a.

According to the possible embodiment of the method steps and method sequences in FIG. 2, the management control device 4 may determine characteristic operating parameters 12 of the respective electrolysis device 5 by the state detection device 11. By monitoring these characteristic operating parameters 12 over time state characteristics 16 of the respective electrolysis device 5 may be determined. Based on the characteristic operating parameters 12 and the state characteristics 16 the management control device 4 may determine feasible working states 17. These feasible working states 17 may be characterized by advantageous states of the respective electrolysis device 5 in particular, for example, by advantageous states with regard to the efficiency or the service life of the respective electrolysis device 5. For example, an idle state, a rinsing state or other states may also be characterized by the feasible operating states 17. In any case, the feasible working states 17 include several feasible states of an electrolysis device 5 which may subsequently result in a set of feasible working states 17 which may be mapped as a single map. In addition, the feasible working states 17 of an electrolysis device 5 may include meta information of the respective electrolysis device 5. This meta information may in general be extracts from the current and/or historical characteristic operating parameters 12 and/or from the state characteristics 16.

According to the feasible working states 17 a control and/or regulation loop may be set up with a resistance function 18 for influencing the respective target working state 10 of an electrolysis device 5. The resistance function 18 may influence the respective target working state 10 of an electrolysis device 5 in such a way that the target working state 10 is changed. This results in the advantageous effect already described in detail that the respective electrolysis device 5 may be protected with regard to non-beneficial, harmful or undesired working states. At the same time, the respective management control device 4 may balance the feasible working states 17 with the resistance function 18 which in any case results in current feasible working states 17.

The feasible working states 17a, 17b of the electrolysis devices 5a, 5b may form a processing capacity 13a of the management apparatus 3a within a management control device 2. Depending on the composition of this processing capacity 13 it can also contain current, possible or historical unit states. As an additional control and/or regulation loop within the management control device 4 an influencing of the target operating range 9a specified by the system control device 2 by a respective weighting function 30 may be provided. By using his respective weighting function 30 another control and/or regulation circuit within each management apparatus 3 may be used to tune the respective management apparatus 3 in a high-performance manner. In any case, the processing capacity 13 of a management apparatus 3 may be transmitted to the system control device 2.

The system control device 2 may then, on the basis of the transmitted processing capacities 13 of the respective management apparatus 3, carry out a balancing 14 between the supply capacity that can be obtained and utilized 7 and the processing capacities 13. As additional information, the previously mentioned meta information of the respective electrolysis devices 5 for the balancing 14 of the system control device 2 is provided. A plant analysis 31 may also be carried out. The plant analysis 31 may be based on collected information, especially over a longer period of time, as well as alternative data that can be recorded via the communication interface 8. This means that the electrolysis plant may be operated in a variety of ways. In addition to the operating modes already described, previously predictive operating modes and/or operating modes based on a trend analysis of usage behavior or supply capacity may thus be implemented. Finally, the operating ranges 14 may be adjusted by balancing 9. It should be mentioned at this point that the method steps and/or the method sequences do not have a defined time sequence. Rather, individual method steps and/or method sequences may be carried simultaneously.

It is therefore conceivable that a variety of possible operating modes of the electrolysis plant 1 may be realized. For example, the possibility of operating a regulation service for an electrical supply network should be mentioned again. It is conceivable that entire areas of the electrolysis plant 1 such as the management apparatus 3a may be set to standby mode. If by the communication interface 8 and the corresponding supply capacity 7 that can be obtained and utilized a specification for the utilization of a defined amount of electrical energy from the system control device 2 is received, the management apparatus 3a, which is in standby mode, may immediately, via the transmission of a new target operating range 9a, activate the process of electrolysis by the electrolysis devices 5a, 5b allocated to the management apparatus 3a. With regard to this exemplary embodiment, it should be noted that in the allocation method and in the communication of the system control device 2 with the management control devices 4 no hierarchical levels are skipped. Referring back to the schematic representation of the structural design of the electrolysis plant 1 in FIG. 1 the same principle applies. This means that for each management apparatus 3 of the electrolysis plan 1, it is ensured that each management apparatus 3 is independently controlled by the respective management control device 4. As already emphasized, this hierarchical structure may have far-reaching advantages in terms of the computing power of the individual control devices. As the complexity of the method is reduced for each individual control device, real-time control may be implemented in a high-performance manner.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or combinations of features from the different exemplary embodiments shown and described may represent independent inventive solutions. The object underlying the independent inventive solutions can be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE SIGNS

1 electrolysis plant 30 weighting function
2 system control device 31 plant analysis
3 management apparatus
4 management control device
5 electrolysis device
6 electrical supply
7 supply capacity
8 communication interface
9 target operating range
10 target working state
11 state detection device
12 characteristic operating parameters
13 processing capacity
14 balancing
15 target working states
16 state characteristics
17 feasible working states
18 resistance function
19 water treatment
20 water tank
21 water supply unit
22 gas treatment unit
23 heat exchanger unit
24 current transformer unit
25 electrolyte storage tank
26 electrolyte preparation device
27 electrolyte pumping device
28 heat transfer unit
29 power distribution unit

1. A method for allocating electrical energy within an electrolysis plant for producing oxygen and hydrogen, the electrolysis plant comprising a system control device, and at least two management apparatuses,
wherein the electrolysis plant comprises at least one water treatment, a water tank, a water supply unit, a pressurization and/or gas treatment unit for hydrogen gas, a heat exchanger unit and/or a power conversion unit for supplying the at least two management apparatuses,
the at least two management apparatuses each comprising at least one management control device and at least two electrolysis devices,
wherein each of the at least two management apparatuses for supplying the respective at least two electrolysis devices comprises at least one electrolyte storage tank, an electrolyte preparation device, an electrolyte pumping device, a heat transfer unit and/or a power distribution unit,
wherein the allocation method comprises the following method steps:
detecting a supply capacity of electrical energy that can be obtained and utilized from an electrical supply via a communication interface of the system control device,
determining a respective target operating range for each of the at least two management apparatuses by the system control device,
transmitting the intended target operating ranges to the respective one of the at least two management apparatuses,
determining a respective target operating state or the target operating states for each electrolysis device by the respective management control device of the respective management apparatus,
specifying the intended target operating state for the respective electrolysis device determining the characteristic operating parameters of each electrolysis device by a respective management control device of the at least two management devices by means of a respective state detection device,
wherein the respective management control device of the at least two management apparatuses determines an available processing capacity of the management apparatuses and transmits it to the system control device,
wherein the system control device performs a balancing between the available processing capacities of the at least two management apparatuses and the supply capacity that can be obtained from and utilized by the electrical supply,
wherein the system control device determines an adapted target operating range for each of the at least two management apparatuses on the basis of this balancing of the capacities and specifies it for the at least two management apparatuses,
wherein the electrical energy that can be obtained and utilized from the electrical supply is allocated to each of the at least two management apparatuses according to the respective target operating range,
wherein each management control device determines an adapted target working state on the basis of the respective adapted target operating range and specifies it for the electrolysis devices coupled to the respective management apparatuses, and
wherein each of the electrolysis devices is allocated an amount of electrical energy corresponding to the respective target working state.

2. The method according to claim 1, wherein the electrical supply is provided by at least one of an energy generating company, an energy production facility, an energy generating community, an energy supply service provider, a renewable energy sources.

3. The method according to claim 1, wherein the respective target operating range for the at least two management apparatuses comprises at least one mode of operation plus a feasible consumption of electrical power.

4. The method according to claim 1, wherein the system control device is configured to determine at least one of an operating mode, a rinsing mode, an idle mode, a maintenance mode, an emergency mode, a start-up mode, a shutdown mode an electrolysis mode, by balancing the available processing capacities and the utilizable supply capacity.

5. The method according to claim 1, wherein the respective target working state for an electrolysis device comprises at least one consumption of electrical power, which electrical power is used by the electrolysis process.

6. The method according to claim 1, wherein the characteristic operating parameters are defined as a parameter set formed from measured variables, which parameter set comprises at least one of the electrical power consumption, the electrolyte or cell temperature, the volume flow of the electrolyte, the pressure or the degree of purity of the hydrogen gas produced, the pressure of the electrolyte, or the cell voltage.

7. The method according to claim 1, wherein each state detection device of a management apparatus comprises at least one equivalent set of sensors for each electrolysis device, wherein each sensor may be activated or put into standby mode by means of the state detection device.

8. The method according to claim 1, wherein each management control device determines state characteristics for each electrolysis device by monitoring the characteristic operating parameters during operation of the plant, which state characteristics comprise at least one of the efficiency, the working state, the expected remaining service life, the start-up behavior and/or the power reserve of the respective electrolysis device.

9. The method according to claim 1, wherein the processing capacity of each management apparatus is determined from working states that can be implemented by the electrolysis devices and meta-information of the electrolysis devices by the respective management control device.

10. The method according to claim 1, wherein the intended target operating state for each electrolysis device is adapted by means of a respective resistance function, which resistance function forms a weighted counter-measure against a disadvantageous working state of the respective electrolysis device, in particular a disadvantageous working state with regard to safety, efficiency and/or service life of the respective electrolysis device.

11. The method according to claim 10, wherein a blocking state of the electrolysis device may be activated by the respective resistance function, which blocking state prevents the allocation of electrical energy and/or influences the supply of electrolyte.

12. The method according to claim 1, wherein the intended target operating range is adapted for each management apparatus by means of a respective weighting function, wherein the weighting function forms a weighted countermeasure against a disadvantageous operating state of the respective management apparatus, the disadvantageous operating state includes one of safety, efficiency and/or service life of the respective management apparatus.

13. The method according to claim 1, wherein a bidirectional communication connection with at least one further electrolysis plant, an internet-based interface and/or a database server may be established by means of the communication interface of the system control device.

14. The method according to claim 1, wherein the system control device is configured to perform a plant analysis on the basis of historical and/or current processing capacities and/or on the basis of external data, wherein the external data is received by the communication interface, wherein the plant analysis comprises as a result at least one degree of utilization of the electrolysis plant, determined over a period of time, based on a trend analysis of the utilization behavior of the electrolysis device or the supply capacity.

15. A method for allocating electrical energy within an electrolysis plant for producing oxygen and hydrogen, the electrolysis plant comprising:
a system control device; and
a management apparatus,
wherein the electrolysis plant comprises a water treatment, a water tank, a water supply unit, a pressurization and/or gas treatment unit for hydrogen gas, a heat exchanger unit and/or a power conversion unit for supplying the management apparatus,
the management apparatus comprising a management control device and an electrolysis device,
wherein the management apparatus includes an electrolyte storage tank, an electrolyte preparation device, an electrolyte pumping device, a heat transfer unit and/or a power distribution unit,
wherein the allocation method comprises the following method steps:
detecting a supply capacity of electrical energy that can be obtained and utilized from an electrical supply via a communication interface of the system control device,
determining a respective target operating range for the management apparatus,
transmitting the intended target operating range to the management apparatus,
determining a target operating state for the electrolysis device, and
determining the characteristic operating parameters of the electrolysis device by a respective management control device of the management device.

16. The method according to claim 15, wherein the management control device of the management apparatus determines an available processing capacity of the management apparatus.

17. The method according to claim 15, wherein the system control device performs a balancing between the available processing capacities of the management apparatus and the supply capacity.

18. The method according to claim 15, wherein the system control device determines an adapted target operating range for the management apparatus.

19. The method according to claim 15, wherein the management control device determines an adapted target working state on the basis of a target operating range.

20. The method according to claim 15, wherein the electrolysis device is allocated an amount of electrical energy corresponding to a respective target working state.
